(19) United States
(12) Patent Application Publication
(10) Pub. No.: US 2010/0206641 A1
(43) Pub. Date: Aug. 19, 2010

(54) Chamfered Pointed Enhanced Diamond Insert

(76) Inventors: David R. Hall, Provo, UT (US); Ronald B. Crockett, Payson, UT (US)

Correspondence Address: TYSON J. WILDE;NOVATEK INTERNATIONAL, INC., 2185 SOUTH LARSEN PARKWAY, PROVO, UT, 84606, US

(21) Appl. No.: 12/372,302

(22) Filed: Feb. 17, 2009

(51) Int. Cl. E21B 10/56; E21B 10/46; B05D 3/12

(52) U.S. Cl. 175/426; 427/350

(57) ABSTRACT

In one aspect of the present invention, a high-impact resistant tool comprises a superhard material bonded to a substrate at a non-planer interface, the superhard material comprising substantially pointed geometry with a substantially conical portion, the substantially conical portion comprising a tapered side wall with at least two different, contiguous slopes that form an angle greater than 135 degrees, and the thickness from an apex of the superhard material to the interface is greater than the thickness of the substrate.

### BACKGROUND OF THE INVENTION

The invention relates to high-impact resistant tools, specifically those used in machinery such as earth-boring drill bits. These tools are commonly subjected to high impact loads, vibrations, high temperatures and pressures, and other adverse conditions. Frequent replacement of the high-impact resistant tools is undesirable, though often necessary due to spalling, delamination, and abrasive wear. Accordingly, efforts have been made to increase the life of such tools.

Such efforts are disclosed in U.S. Pat. No. 4,109,737 to Bovenkerk, which is herein incorporated by reference for all that it contains. Bovenkerk discloses a rotary drill bit for rock drilling comprising a plurality of cutting elements mounted by interference-fit in recesses in the crown of the drill bit. Each cutting element comprises an elongated pin with a thin layer of polycrystalline diamond bonded to the free end of the pin.

U.S. Pat. No. 5,544,713 to Dennis, which is herein incorporated by reference for all that is contains, discloses a cutting element which has a metal carbide stud having a conic tip formed with a reduced diameter hemispherical outer tip end portion of said metal carbide stud. A layer of polycrystalline material, resistant to corrosive and abrasive materials, is disposed over the outer end portion of the metal carbide stud to form a cap. An alternate conic form has a flat tip face. A chisel insert has a transecting edge and opposing flat faces. It is also covered with a PDC layer.

U.S. Pat. No. 6,484,826 to Anderson which is herein incorporated by reference for all that it contains, discloses enhanced inserts are formed having a cylindrical grip and a protrusion extending from the grip. An ultra hard material layer is bonded on top of the protrusion. The inserts are mounted on a rock bit and contact the earth formations off center. The ultra hard material layer is thickest at a critical zone which encompasses a major portion of the region of contact between the insert and the earth formation. Transition layers may also be formed between the ultra hard material layer and the protrusion so as to reduce the residual stresses formed on the interface between the ultra hard material and the protrusion.

U.S. Pat. No. 5,848,657 by Flood et al, which is herein incorporated by reference for all that it contains, discloses domed polycrystalline diamond cutting element wherein a hemispherical diamond layer is bonded to a tungsten carbide substrate, commonly referred to as a tungsten carbide stud. Broadly, the inventive cutting element includes a metal carbide stud having a proximal end adapted to be placed into a drill bit and a distal end portion. A layer of cutting polycrystalline abrasive material disposed over said distal end portion such that an annulus of metal carbide adjacent and above said drill bit is not covered by said abrasive material layer.

### BRIEF SUMMARY OF THE INVENTION

In one aspect of the present invention, a high-impact resistant tool comprises a superhard material bonded to a carbide substrate at a non-planer interface. The superhard material comprises substantially pointed geometry with a substantially conical portion, the substantially conical portion comprising a tapering side wall with at least two different, contiguous slopes that form an angle greater than 135 degrees. The thickness from an apex of the superhard material to the non-planer interface is greater than the thickness of the carbide substrate.

At the non-planer interface, the carbide substrate may comprise a tapered surface starting from a cylindrical rim of the substrate and ending at an elevated flatted central region formed in the substrate. The diameter of the flatted central region may comprise a diameter between one fourth and three-fourths the diameter of the cylindrical rim of the substrate.

The volume of the superhard material may be 75 to 150 percent of the volume of the carbide substrate. The thickness from the apex of the superhard material to the non-planer interface may be greater than twice the thickness of the carbide substrate. The apex of the superhard material may comprise a radius between 0.050 inches to 0.125 inches.

A substantially circumferential edge may be formed at an interface between the substantially conical portion and the apex's radius. The substantially circumferential edge may be radiused or chamfered to reduce the sharpness of the edge. The apex may comprise a radius greater than a diameter of the substantially circumferential edge. The substantially circumferential edge may comprise a diameter less than one tenth the diameter of the cylindrical rim of the substrate.

The tool may be asymmetric with respect to a central axis, and may be used in a drag bit or other types of earth-boring machines.

In another aspect of the present invention, a method for forming a high-impact resistant tool comprises providing a pre-shaped can containing diamond powder adjacent a carbide substrate, sintering the pre-shaped can in a high-pressure, high-temperature press to form a high impact tool with a substantially conical geometry, the sintered diamond comprising a greater volume than the substrate, removing the can from the sintered diamond and carbide substrate, and forming a chamfer proximate the apex of the substantially conical geometry on the high impact tool.

The diamond powder and carbide substrate may be loaded into the can in an inert environment. The inert environment may comprise a vacuum, or an inert gas such as argon. The diamond powder and substrate may be heated before the can is sealed, and the method may comprise an additional step of sealing the can by melting a disk inside the can. The chamfer proximate the apex may be formed by grinding.

### BRIEF DESCRIPTION OF THE DRAWINGS

FIG. 1a is a perspective view of an embodiment of a high impact tool.

FIG. 1b is a cross-sectional view of an embodiment of a high impact tool.

FIG. 2 is a cross-sectional view of another embodiment of a high impact tool.

FIG. 3 is a cross-sectional view of another embodiment of a high impact tool.

FIG. 4 is a cross-sectional view of another embodiment of a high impact tool.

FIG. 5 is an orthogonal view of another embodiment of a high impact tool.

FIG. 6 is an enlarged cross-sectional view of another embodiment of a high impact tool.

FIG. 7 is an enlarged cross-sectional view of another embodiment of a high impact tool.

FIG. 8 is a cross-sectional view of an embodiment of a high impact tool and a formation.

FIG. 9 is a perspective view of an embodiment of a drag bit.

FIG. 10 is a diagram of an embodiment of a method for forming a high impact tool.

FIG. 11 is a cross-sectional view of an embodiment of a pre-shaped can, diamond powder, and carbide substrate.

FIG. 12 is a perspective view of an embodiment of a high impact tool and a grinding wheel.

### DETAILED DESCRIPTION OF THE INVENTION AND THE PREFERRED EMBODIMENT

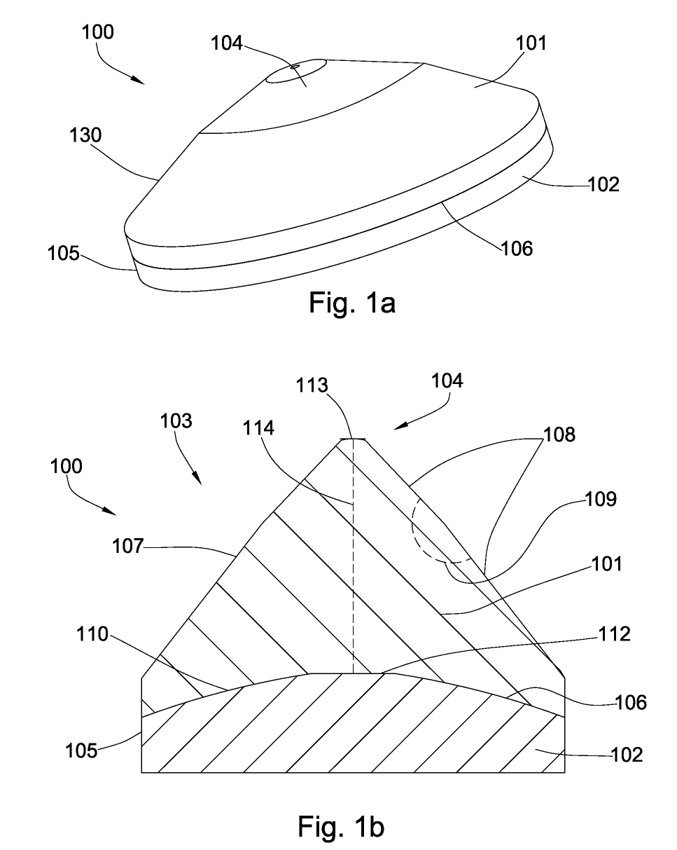

Referring now to the figures, FIG. 1a discloses a high impact tool 100 according to the present invention. The high impact tool 100 comprises superhard material 101 bonded to a carbide substrate 102 at a non-planer interface 106. The superhard material 101 comprises a substantially conical portion 103 with an apex 104. The superhard material 101 may comprise polycrystalline diamond, cubic boron nitride, or another suitably hard crystalline material. The carbide substrate 102 may comprise a generally cylindrical rim 105, and may be adapted for attachment to an implement such as a drag bit by brazing or an interference fit. In some embodiment, the tool 100 will be used in picks, milling picks, trenching picks, mining picks, bits, roller cone bits, and percussion bits.

FIG. 1b discloses a high impact tool 100 according to the present invention, comprising a superhard material 101 with substantially conical geometry 103 bonded to a carbide substrate 102 at a non-planer interface 106.

The substantially conical geometry 103 comprises a tapering side wall 107 with at least two different, contiguous slopes 108. The at least two different, contiguous slopes 108 form an included angle 109 of greater than 135 degrees, and may be formed during sintering in an HPHT press, by grinding, or combinations thereof. Preferably, the angle 109 is substantially 174 degrees.

The substantially conical geometry 103 comprises an apex 104. The apex 104 may comprise a radius 113 of between 0.050 and 0.125 inches, most preferably 0.080 inches. The thickness 114 between the apex and the non-planer interface is greater than the thickness of the carbide substrate 102, and may be twice the thickness of the carbide substrate. The carbide substrate would be understood by one of ordinary skill in the art to be made primarily of a cemented metal carbide and to comprise features that allow the tool to be attached to bits, picks, or other objects. The substrate may comprise diameter for press fitting or an interface capable of being bonded to the bit, pick, or other object.

The non-planer interface 106 may comprise a substantially tapered surface 110 disposed intermediate a generally cylindrical rim 105 and an elevated, flatted central region 112. The elevated, flatted central region 112 may comprise a diameter between one-fourth and three-fourths the diameter of the cylindrical rim 105. The tapered surface 110 may comprise a constant slope, a curve with constant radius, a curve with varying radius, or combinations thereof. It is believed that the non-planer interface 106 improves the mechanical attachment between the superhard material 101 and the carbide substrate 102 by increasing the bond surface area. The non-planer surface may also comprise grooves, ribs, nodules, or other geometric features intended to improve the mechanical attachment.

The volume of the superhard material 101 may be greater than the volume of the carbide substrate 102, preferably between 75 and 150 percent of the volume of the carbide substrate. It is believed that the large volume of diamond with respect to the carbide substrate combined with the substantially conical geometry improves impact resistance.

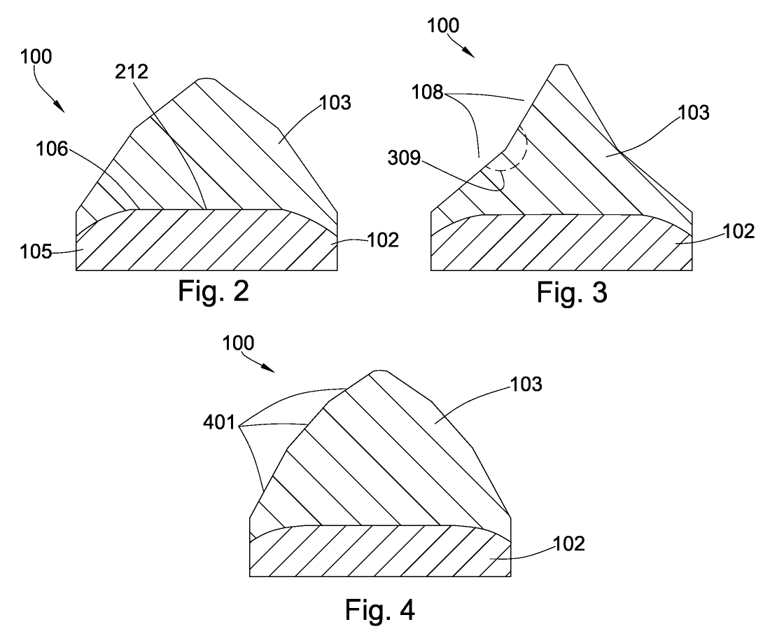

Referring now to FIG. 2, another embodiment of a high impact tool 100 comprises a substantially conical portion 103 bonded to a carbide substrate 102 at a non-planer interface 106. Non-planer interface 106 comprises an elevated, flatted central region 212 that is substantially three-fourths of the diameter of a cylindrical rim 105 of the carbide substrate 102.

FIG. 3 discloses another embodiment of a high-impact tool 100. In this embodiment, a substantially conical portion 103 bonded to a carbide substrate 102 comprises two different, contiguous slopes 108 that form an included angle 309 greater than 180 degrees, thus, forming an overall concave side wall.

FIG. 4 discloses another embodiment of a high impact tool 100. In this embodiment, a substantially conical portion 103 bonded to a carbide substrate 102 comprises three different, contiguous slopes 401.

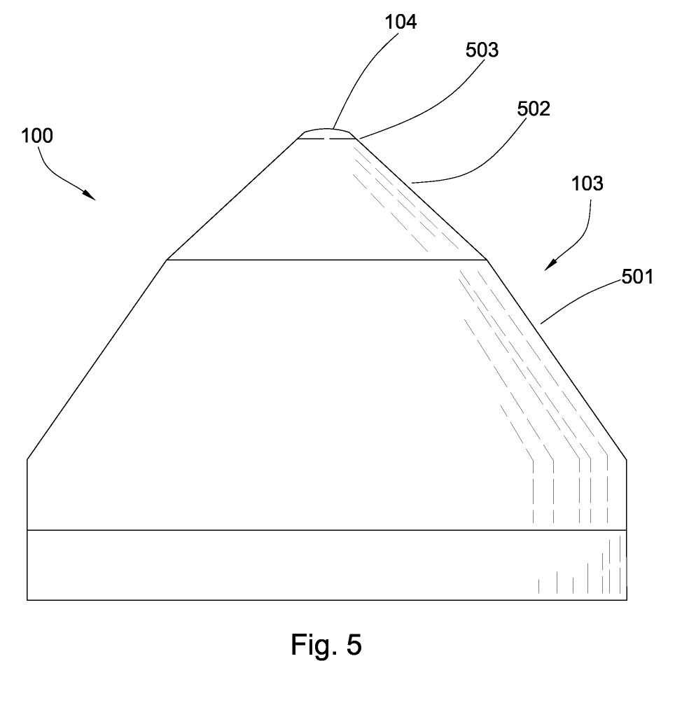

FIG. 5 discloses another embodiment of a high-impact tool 100. High impact tool 100 comprises a substantially conical portion 103 with a lower slope 501 and an upper slope 502. In this embodiment, the upper slope 501, lower slope 502, or both may be formed by grinding or another machining operation. This may create a substantially circumferential edge 503 proximate the apex 104 of the substantially conical portion 103. The substantially circumferential edge 503 may be undesirably sharp after the forming operation and may be subject to accelerated abrasive wear or stress concentrations. Therefore, it may be desirable to radius or chamfer the substantially circumferential edge.

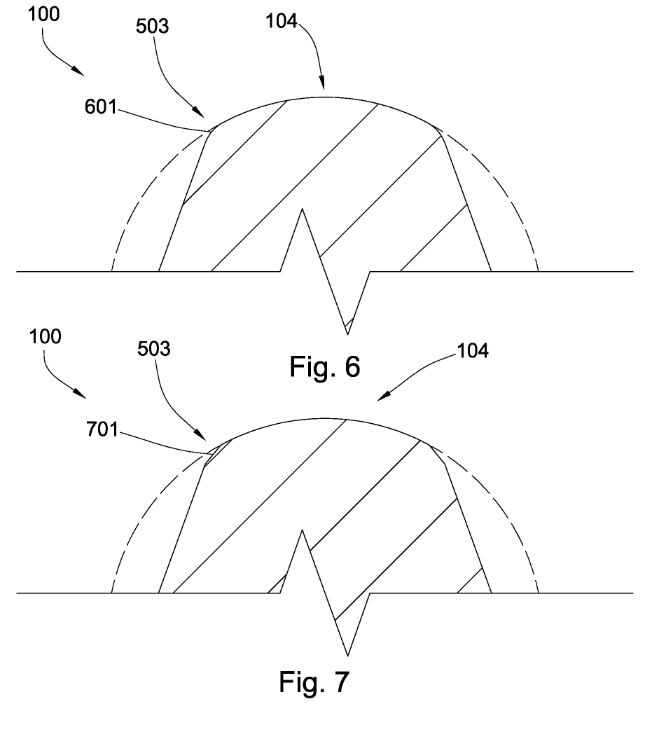

FIG. 6 is an enlarged view and discloses another embodiment of a high impact tool 100 comprising a substantially circumferential edge 503 proximate an apex 104. In this embodiment, the substantially circumferential edge 503 comprises a radius 601. The radius 601 may be less than 0.005 inches, and may be formed with a grinding wheel, a sanding belt or disk, or by hand. Because the high impact tool comprises a superhard material such as polycrystalline diamond, the abrasive media used to form the radius may comprise hardness equal to or greater than the hardness of the superhard material.

FIG. 7 is an enlarged view and discloses another embodiment of a high impact tool 100. In this embodiment, a substantially circumferential edge 503 proximate an apex 104 comprises a chamfer 701. The chamfer 701 may be formed in a similar way to those previously discussed for the radius.

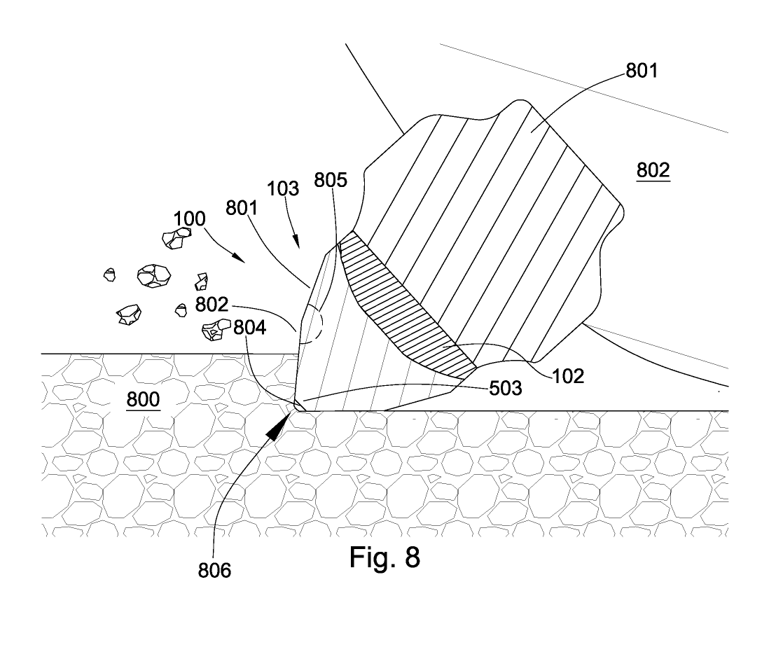

FIG. 8 discloses an embodiment of a high impact tool 100 impinging a formation 800. The high impact tool comprises superhard material with a substantially conical portion 103. The high impact tool 100 comprises a carbide substrate 102 and may be brazed or otherwise affixed to a carbide bolster 801. The carbide bolster may be attached to an earth boring tool such as the body of a drag bit 802. The body of the drag bit 802 may comprise alloyed steel, a steel carbide matrix, or combinations thereof. The carbide bolster 801 may comprise a higher stiffness than the bit body 802, thus deflecting less under similar impacts and providing a more stable base for the impact tool 100. This may increase the life of the high impact tool by preventing flexure-induced fractures in the superhard material. The carbide bolster may be attached to the bit body by brazing, a press fit, or another method.

It is believed that cylindrical impact tools currently in use provide an aggressive cutting edge when new, but quickly dull during use. The aggressive cutting edge may also be susceptible to spalling and delamination; accordingly, many impact tools in commercial use feature blunted or hemispherical profiles. To maintain cutting speed with either worn or intentionally blunt impact tools, it may be necessary to increase the weight on bit (WOB) which in turn places more stress on the tools and accelerates wear and may have other undesirable effects.

It is believed that impact tools featuring a substantially conical portion of superhard material may provide substantially longer life than cylindrical impact tools. It is thought that with correct orientation, the impact tool with a substantially conical portion experiences less shear stress in use than a cylindrical impact tool. In addition, the apex of the substantially conical portion may penetrate the formation more effectively and may create quasi-hydrostatic forces proximate the apex. This reduces the effective (or von Mises) stress level in the tool and thus may reduce occurrence of failure. However, the substantially conical impact tools do not cut as aggressively as new cylindrical impact tools, and thus initially require higher WOB to achieve the same drilling rate.

It is therefore desirable to combine the long life and resistance to spalling and delamination of substantially conical impact tools with the aggressive initial cutting action of cylindrical impact tools.

Referring again to FIG. 8, the substantially conical portion 103 comprises two different, contiguous slopes 801 and 802. The slope 802 may form a substantially circumferential edge 503 proximate an apex 804 of the substantially conical portion. A diameter of the substantially circumferential edge may be less than a radius of the apex. The included angle 805 between slopes 801 and 802 is greater than 135 degrees and may be substantially 174 degrees in this embodiment.

In this way, an aggressive cutting point 806 is formed at the apex 804 of the high impact tool, while retaining a broad geometry with a high volume of superhard material proximate the carbide substrate 102 of the high impact tool to provide buttressing and impact absorption. It is thought that this geometry will reduce the initial WOB required for the drilling operation, but as the high impact tool wears the substantially conical geometry will be less susceptible to spalling or delamination.

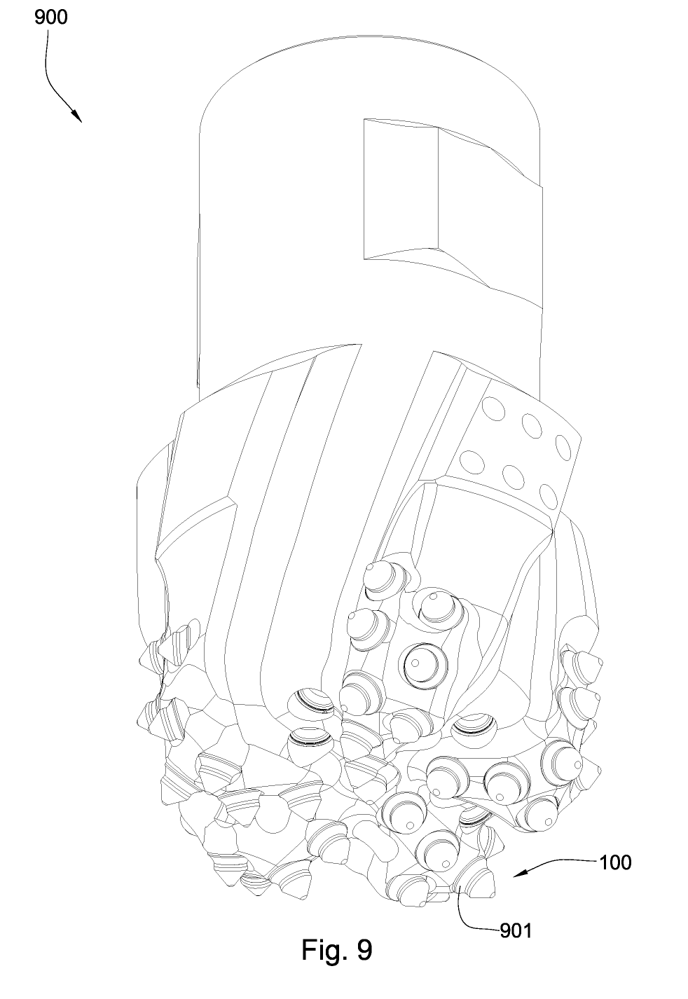

FIG. 9 discloses an embodiment of a drag bit 900 comprising a plurality of high impact tools 100. High impact tools may be brazed to carbide bolsters 901, after which the bolsters may be press fitted or brazed to the drag bit 900.

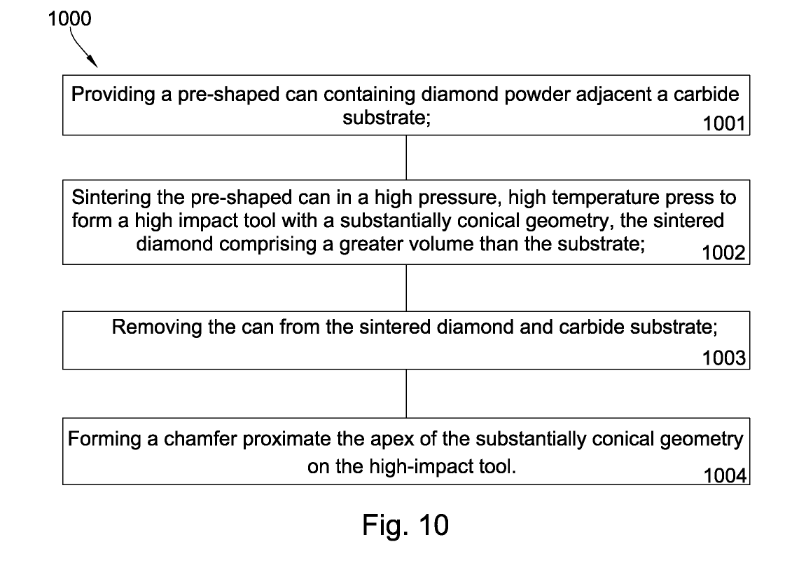

FIG. 10 is a method 1000 for forming a high impact tool comprising the steps of providing 1001 a pre-shaped can containing diamond powder adjacent a carbide substrate; sintering 1002 the pre-shaped can in a high pressure, high temperature press to form a high impact tool with substantially conical geometry, the sintered diamond comprising a greater volume than the substrate; removing 1003 the pre-shaped can from the sintered diamond and carbide substrate; and forming 1004 a chamfer proximate the apex of the substantially conical geometry of the high impact tool.

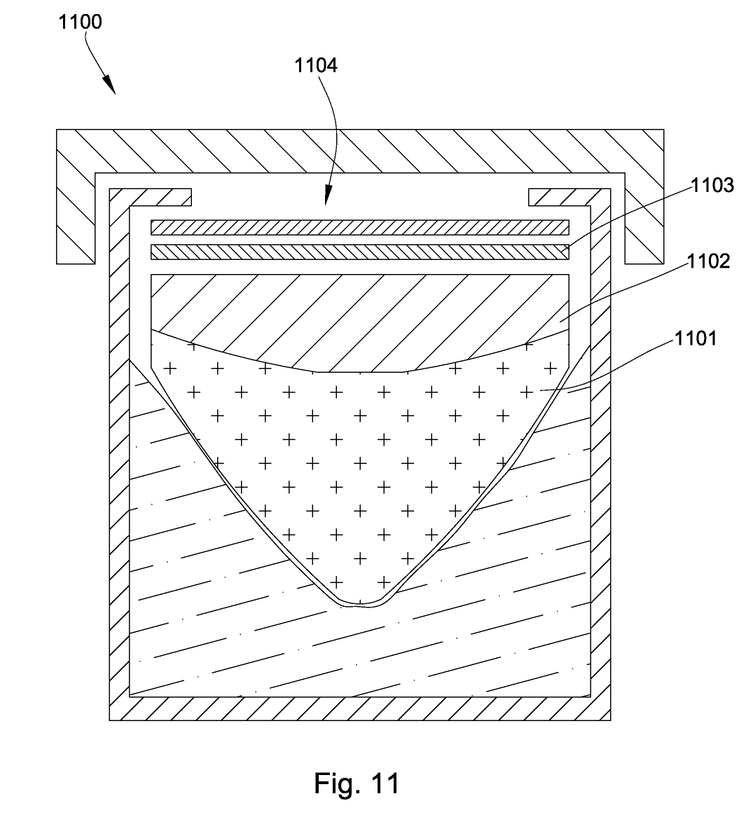

FIG. 11 discloses an embodiment of a pre-shaped can 1100 containing diamond powder 1101 adjacent a carbide substrate 1102. The can 1100 may comprise niobium or a niobium alloy. A meltable disk 1103 may be disposed proximate an opening 1104 of the can 1100. The meltable disk 1103 may be made from copper, copper alloys, or another material with sufficiently low melting temperature. The can and contents may be assembled in an inert environment comprising a substantial vacuum or an inert gas such as argon to prevent environmental contamination. After assembly, the can may be pre-heated in an inert environment to remove any impurities present in the diamond powder. This may be done at a temperature between 800 and 1050 degrees Celsius for 15 to 60 minutes. The pre-shaped can may undergo an additional heating cycle to melt the disk 1103 and seal the diamond powder and carbide substrate in the can. The melting temperature may be higher than the cleansing temperature, preferably between 1000 and 1200 degrees Celsius. This temperature may be maintained for 2 to 25 minutes. The pre-shaped can may now be ready for processing in a high pressure, high temperature press.

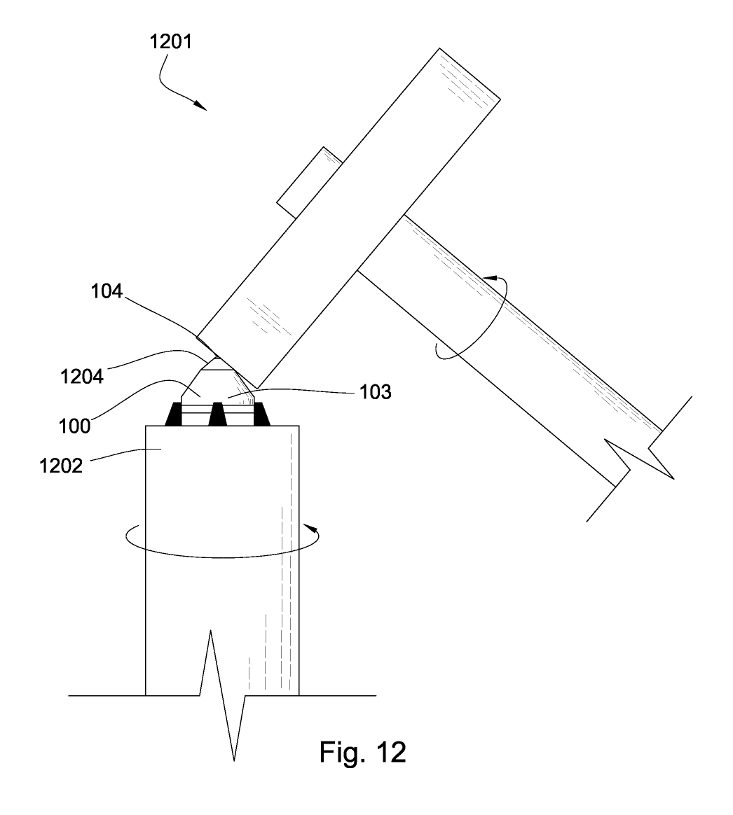

FIG. 12 discloses an embodiment of a high impact tool 100 mounted in a grinding tool 1201. The high impact tool 100 is mounted in a rotating chuck or collet, and the substantially conical geometry is brought into contact with a rotating grinding wheel 1203 to form a chamfer 1204 proximate the apex 104 of the substantially conical geometry 103. Grinding wheel 1203 may comprise diamond or other superhard media, and may be air or fluid cooled.

Whereas the present invention has been described in particular relation to the drawings attached hereto, it should be understood that other and further modifications apart from those shown or suggested herein, may be made within the scope and spirit of the present invention.

What is claimed is:

1. A high impact resistant tool, comprising:
a superhard material bonded to a cemented metal carbide substrate at a non-planer interface;
the superhard material comprising substantially pointed geometry with a substantially conical portion;
the substantially conical portion comprising a tapering side wall with at least two different, contiguous slopes that form an angle greater than 135 degrees; and
the thickness from an apex of the superhard material to the interface is greater than the thickness of the substrate.

2. The tool of claim 1, wherein at the interface the substrate comprises a tapered surface starting from a cylindrical rim of the substrate and ending at an elevated flatted central region formed in the substrate.

3. The tool of claim 2, wherein the central flatted region comprises a diameter of one fourth to three fourths the diameter of the cylindrical rim.

4. The tool of claim 1, wherein the volume of the superhard material is 75 to 150 percent of a volume of the carbide substrate.

5. The tool of claim 1, wherein the thickness from the apex to the non-planer interface is at least twice the thickness of the substrate.

6. The tool of claim 1, wherein the apex comprises a radius between 0.050 and 0.125 inches.

7. The tool of claim 6, wherein a substantially circumferential edge is formed at an interface between the substantially conical portion and the apex's radius.

8. The tool of claim 7, wherein the substantially circumferential edge is radiused.

9. The tool of claim 7, wherein the substantially circumferential edge is chamfered.

10. The tool of claim 7, wherein the apex comprises a radius greater than a diameter of the substantially circumferential edge.

11. The tool of claim 7, wherein the substantially circumferential edge comprises a diameter less than one-tenth the diameter of the cylindrical rim of the substrate.

12. The tool of claim 1, wherein the tool is asymmetric.

13. The tool of claim 1, wherein the tool is used in a drag bit.

14. A method for forming a high-impact tool, comprising:
providing a pre-shaped can containing diamond powder adjacent a carbide substrate;
sintering the pre-shaped can in a high pressure, high temperature press to form a high impact tool with a substantially conical geometry, the sintered diamond comprising a greater volume than the substrate;
removing the can from the sintered diamond and carbide substrate;
forming a chamfer proximate the apex of the substantially conical geometry on the high-impact tool.

15. The method of claim 14, wherein the powder and substrate are loaded into the pre-shaped can in an inert environment.

16. The method of claim 15, wherein the inert environment comprises a vacuum.

17. The method of claim 14, wherein the powder and substrate are pre-heated in the pre-shaped can before the can is sealed.

18. The method of claim 14, wherein the method includes an additional step of sealing the can by melting a disk within the can.

19. The method of claim 14, wherein the chamfer is formed by grinding.
